(19) United States
(12) Patent Application Publication
(10) Pub. No.: US 2025/0362373 A1
(43) Pub. Date: Nov. 27, 2025

(54) DEVICES, SYSTEMS, AND METHODS FOR AGRICULTURAL NAVIGATION AND POSITIONING

(71) Applicant: Ag Leader Technology, Ames, IA (US)

(72) Inventors: Josue Calderon, Apex, NC (US); Trent Anagnostopoulos, Ankeny, IA (US); David Wilson, Prairie City, IA (US)

(21) Appl. No.: 19/219,718

(22) Filed: May 27, 2025

Related U.S. Application Data
(60) Provisional application No. 63/651,831, filed on May 24, 2024.

(51) Int. Cl. G01S 5/02; A01B 69/04; G01C 21/20; G05D 1/667

(52) U.S. Cl. CPC G01S 5/02585; A01B 69/008; G01C 21/20; G05D 1/667

(57) ABSTRACT

A relative positioning method is combined with the known absolute pose of a primary vehicle to provide the absolute position and/or pose of the secondary vehicle wherein the secondary vehicle is only equipped with a non-contact relative positioning system. Thereby allowing for numerous advantages such as fleet management, safe vehicle interactions, and further automation at a fraction of the cost of using a sensor suite commonly required to calculate the absolute pose of the secondary vehicle.

### CROSS-REFERENCE TO RELATED APPLICATION(S)

This application claims the benefit under 35 U.S.C. § 119(e) to U.S. Provisional Application 63/651,831, filed May 24, 2024, and entitled Non-Contact Methods for Interactions in Navigational Space of Relatively Located Mobile Systems, and Related Devices and Systems, which is hereby incorporated herein by reference in its entirety for all purposes.

### TECHNICAL FIELD

The disclosure relates to vehicle navigation generally, and to the navigation of agricultural vehicles, more specifically.

### BACKGROUND

Accurate autonomous navigation of ground vehicles is heavily reliant on knowing the vehicle's location and orientation, often referred to as the vehicle's pose. Accurate pose estimation is even more pertinent when multi-agent systems are involved to reduce the risk of collision or to enable vehicular interactions.

As would be understood, most autonomous vehicles operate in specific environments that are, largely, unchanging in terms of the sensor suites that are needed for navigation. For example, autonomous agricultural vehicles tend to operate solely outdoors and, as such, can rely on having near constant GPS visibility whereas autonomous warehouse forklifts or other robots can safely assume that GPS is not a viable solution and instead rely on visual navigation aided by fiducial markers or use an internal GPS like system which may rely on ultrasonics, ultra-wide band (UWB) communication, Bluetooth low energy systems, or other wireless real-time locating system (RTLS).

For vehicles that need to be located both indoors and outside, there are systems available that integrate a GPS unit into the same housing as RTLS systems. However, these are almost exclusively used on manually operated vehicles for warehouse logistics or placed on cargo to ensure safe delivery and assist in locating the cargo once delivered. While the advantages of combination GPS and RTLS systems for localization are clear, the transition from one localization method (e.g. UWB being used inside the warehouse) to another (e.g. GPS in the parking lot) tends to produce a jump or discontinuity in the vehicles estimated pose. While, this discontinuity may not be an issue for a human operator but it has a negative effect and may cause poor control for an autonomous system.

Such issues could also occur if two or more systems are used simultaneously. For example, if one vehicle were using GPS for its pose estimate while another was using BLE, the mismatch in reference frame could cause significant problems were those vehicles to attempt to interact or try to avoid each-other for safety purposes. This negative effect of mismatched reference frames is visible even when both systems are using GPS but the GPS is either of differing quality (e.g. RTK vs WAAS) and/or if they have a different correction source.

### BRIEF SUMMARY

In Example 1, a relative positioning system comprising: a first platform equipped with one or more tags; and a second platform having a known absolute pose and at least one sensor for detecting the one or more tags, wherein the relative positioning system is configured to determine a location of the first platform via the second platform by detecting the one or more tags on the first platform and determining the pose of the first platform relative to the second platform.

Example 2 relates to the navigation system of any of Examples 1 and 3-8, wherein the one or more tags are visual fiducials.

Example 3 relates to the navigation system of any of Examples 1-2 and 4-8, wherein the at least one sensor is a camera.

Example 4 relates to the navigation system of any of Examples 1-3 and 5-8, wherein the one or more tags are ultra-wide band (UWB) receivers.

Example 5 relates to the navigation system of any of Examples 1˜4 and 6-8, wherein the at least one sensor is a UWB transmitter.

Example 6 relates to the navigation system of any of Examples 1-5 and 7-8, further comprising generating guidance for navigation of the second platform to the first platform for unloading or loading.

Example 7 relates to the navigation system of any of Examples 1-6 and 8, wherein the absolute pose of the second platform is known from an on-board GPS and inertial measurement unit (IMU).

Example 8 relates to the navigation system of any of Examples 1-7, wherein the first platform is a grain truck and the second platform is a grain cart.

In Example 9, an agricultural navigation system comprising: a first vehicle comprising a sensor suite capable of determining a first vehicle absolute pose and at least one transmitter, a second vehicle comprising at least one tag capable of being sensed by the at least one transmitter, and a processor in communication with the sensor suite, the processor configured to determine a relative location of the second vehicle based on the first vehicle absolute pose and at least one sensed tag.

Example 10 relates to the agricultural navigation system of any of Examples 9 and 11-16, wherein the one or more tags are visual fiducials.

Example 11 relates to the agricultural navigation system of any of Examples 9-10 and 12-16, wherein the at least one transmitter is a camera.

Example 12 relates to the agricultural navigation system of any of Examples 9-11 and 13-16, further comprising an automatic steering unit in communication with the processor.

Example 13 relates to the agricultural navigation system of any of Examples 9-12 and 14-16, wherein the first vehicle is capable of navigating along GPS based guidance lines and switching to a relative position based guidance line.

Example 14 relates to the agricultural navigation system of any of Examples 9-13 and 15-16, wherein a relative position based guidance line is generated based on the relative position of the second vehicle to the first vehicle.

Example 15 relates to the agricultural navigation system of any of Examples 9-14 and 16, wherein the second vehicle does not include a GPS and IMU sensor suite.

Example 16 relates to the agricultural navigation system of any of Examples 9-15, wherein the first vehicle is a grain cart and wherein the second vehicle is a grain truck.

In Example 17, a method for determining vehicle pose comprising determining an absolute pose of a first platform in a navigational reference frame, sensing at least one tag on a second platform by at least one sensor on the first platform, determining a relative location of the second platform, and locating the second platform in the navigational reference frame.

Example 18, relates to the method of any of Examples 17 and 19-20, wherein the absolute pose of the first platform is determined by locating the first platform in a relative reference frame via an on-board GPS and inertial measurement unit (IMU) and converting the location of the first platform into the navigational reference frame.

Example 19 relates to the method of any of Examples 17-18 and 20 further comprising generating guidance lines for navigation of the first platform to be adjacent to the second platform.

Example 20 relates to the method of any of Examples 17-19 wherein the at least one tag is a visual fiducial.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is rear view of the positioning system fitted to an agricultural vehicle, according to one implementation.

FIG. 1B is an electrical diagram of the operations system in the positioning system, according to one implementation.

FIG. 2 is a diagram of the positioning system determining pose of an agricultural vehicle, as well as its position to another mobile platform, according to one implementation.

FIG. 3 is a two-dimensional diagram of the absolute pose of a target vehicle being determined, according to one implementation.

FIG. 4 is a two-dimensional diagram of the absolute pose of a target vehicle being determined using a body fitted coordinates system, according to one implementation.

FIG. 5 is an overhead view of the position system identifying non-primary vehicles, according to one implementation.

FIG. 6 is a perspective view of the system ensuring minimum spacing between controlled vehicles, according to one implementation.

FIG. 7 is an overhead view of the position system identifying non-primary vehicles using unique identifiers, according to one implementation.

FIG. 8 is a diagram of the positioning system generating a guidance line for a primary vehicle based on the heading of a secondary vehicle, according to one implementation.

FIG. 9 is an overhead view of the positioning system generating a guidance line for a primary vehicle based on the heading of a secondary vehicle in an agricultural field, according to one implementation.

FIG. 10 is an overhead view of the positioning system generating a guidance line for a primary vehicle with a transmitter, based on the heading of a secondary vehicle, according to one implementation.

FIG. 11 is an image of the system managing the feed of grain into grain chambers along the length of a grain trailer, according to one implementation.

FIG. 12 is an image of a grain trailer with grain chambers shown, according to one implementation.

FIG. 13 is a diagram of a flatbed trailer, subdivided into loading bays, which the positioning system may be configured to load cargo into, according to one implementation.

### DETAILED DESCRIPTION

Disclosed herein are various devices, systems, and methods for agricultural navigation, positioning, and localization. In various implementations, the systems and devices are configured to execute one or more algorithms to locate and identify one or more secondary vehicles from a primary vehicle. In further implementations, the systems and devices may generate and command guidance along guidance lines based on the determined location and pose of the primary and secondary vehicles.

As will be discussed further herein, the absolute pose of a first vehicle is known/determined from a sensor suite (optionally a GPS and IMU). The system may then determine the location/pose of a second vehicle having one or more tags by the first vehicle seeing the one or more tags and interpolating the location/pose of the second vehicle based on the relative positioning of the two vehicles. In various implementations, the one or more tags are visual fiducials, such as AprilTags and are seen by a vision sensor (optionally a camera). Various additional or alternative non-contact methods and devices for seeing and detecting the one or more tags are possible and would be appreciated in light of this disclosure.

In certain further implementations, the system may generate guidance lines for any of the vehicles based on the known and determined vehicles pose/location. The system may include or be in communication with an automatic and/or assisted steering system for navigating the generated guidance lines, as would be generally understood. In various further implementations, the vehicles are capable of switching between navigation modes from GPS based guidance to relative position based guidance.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” each of which is incorporated herein by reference.

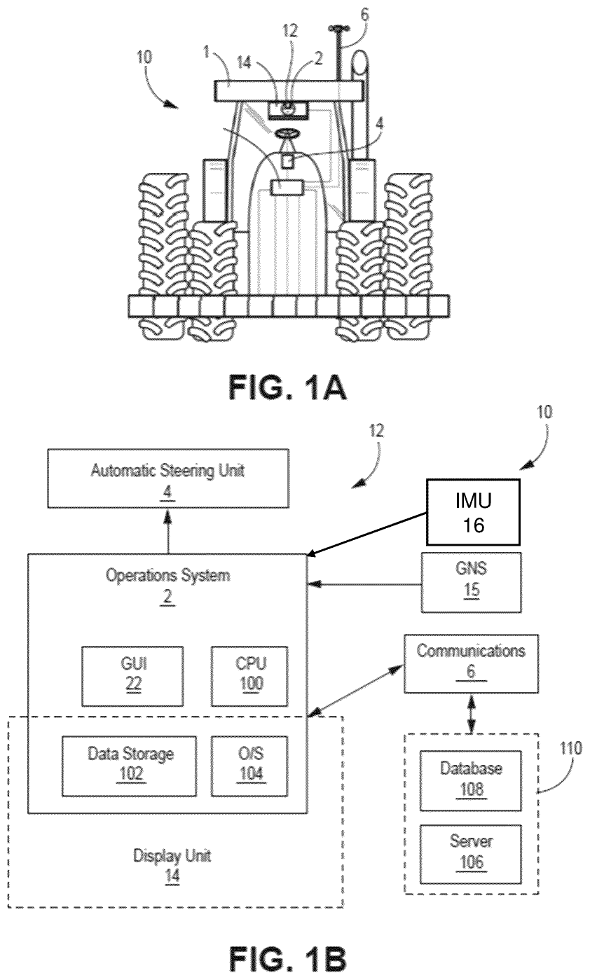

Turning to the drawings in greater detail, FIGS. 1A-1B depict exemplary implementations of the positioning system 10 components fitted to an agricultural vehicle 1. In various implementations, the agricultural vehicle 1 may be a tractor 1, semi, grain cart, harvester, or the like, optionally having an implement such as a planter, as would be understood. It is understood that a variety of vehicles 1 and implements can be utilized in various implementations. It is further understood that the components depicted in FIGS. 1A-1B are optional, and can be utilized or omitted in the various implementations, and that certain additional components may be required to effectuate the various processes and systems described herein. Such additional components may include hardware, software, firmware, and other electronic components that would be known and appreciated by those of skill in the art.

As shown in FIG. 1A, the positioning system 10 has an operations system 2 that comprises or is configured to be operationally integrated with a steering unit 4, such as SteerCommand®, and an optional communications component 6. The system 10 is operationally integrated with at least one in-cab display 14, such as an InCommand® display 14, or other suitable display 14 understood in the art. It is appreciated that certain of these displays 14 feature touchscreens, while others are equipped with necessary components for interaction with the various prompts and adjustments discussed herein, such as via a keyboard or other interface.

In various implementations, the system 10 is also operationally integrated with a GNSS or GPS unit 15, such as a GPS 7500, such that the system 10 is configured to input positional data for use in defining boundaries, locating the tractor 1, plotting guidance, and the like, as would be readily appreciated and as described further herein. Various further implementations, include an inertial measurement unit (IMU) 16 for determining vehicle 1 positioning.

As shown in FIG. 1B, in various implementations, the operations system 2 is optionally in operational communication with the automatic steering unit 4 or controller 4, the communications component 6, and/or GNSS 15. In certain of these implementations, the operations system 2 is housed in the display 14, though the various components described herein can be housed elsewhere, as would be readily appreciated.

As shown in FIG. 1B, the operations system 2 further has one or more optional processing and computing components, such as a CPU/processor 100, data storage 102, operating system 104, and other computing components necessary for implementing the various technologies disclosed herein. It is appreciated that the various optional system 10 components are in operational communication with one another via wired or wireless connections and are configured to perform the processes and execute the commands described herein.

In certain implementations, like that of FIG. 1B, the communications component 6 is configured for the sending and receiving of data for cloud 110 storage and processing, such as to a remote server 106, database 108, and/or other cloud computing components readily understood in the art. Such connections by the communications component 6 can be made wirelessly via understood internet and/or cellular technologies such as Bluetooth, WiFi, LTE, 3G, 4G, or 5G connections and the like. It is understood that in certain implementations, the communications component 6 and/or cloud 110 components comprise encryption or other data privacy components such as hardware, software, and/or firmware security aspects. In various implementations, the operator or enterprise manager or other third parties are able to receive notifications such as adjustment prompts and confirmation screens on their mobile devices, and in certain implementations can review the plotted guidance paths and make adjustments via their mobile phones.

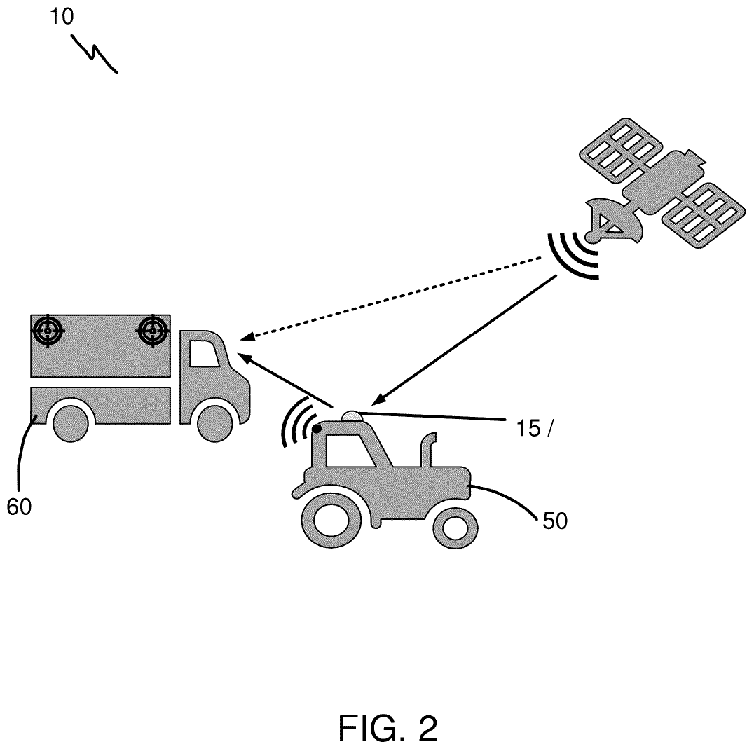

The disclosed system 10, such as shown in FIG. 2, utilizes a master vehicle or platform 50 that has both a known absolute pose (for example by using sensor fusion methods to combine GPS 15 and IMU 16 measurements) and a relative location to another mobile platform or vehicle 60. While these movable platforms 50, 60 might be semi-static, for example, a pallet or an unhooked trailer, the implementations described herein describe the movable platforms 50, 60 as vehicles for clarity and brevity although one or more of the platforms 50, 60 may be static or semi-static.

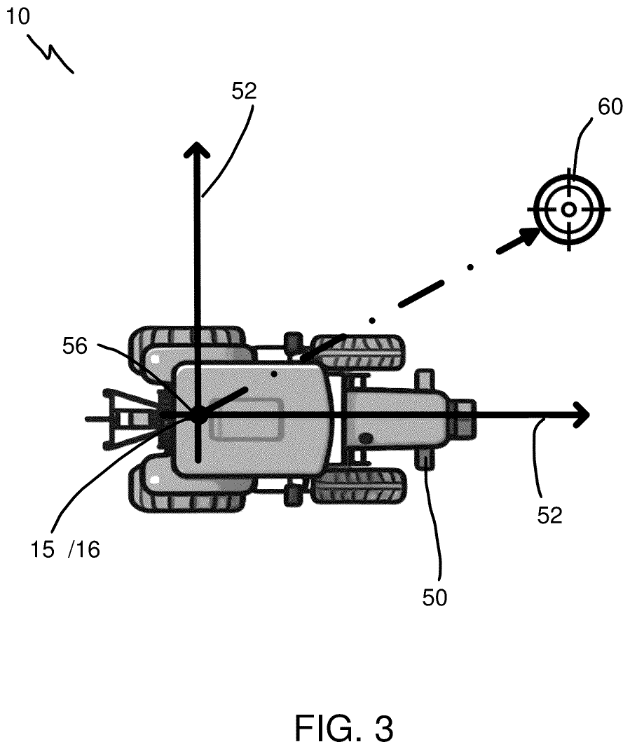

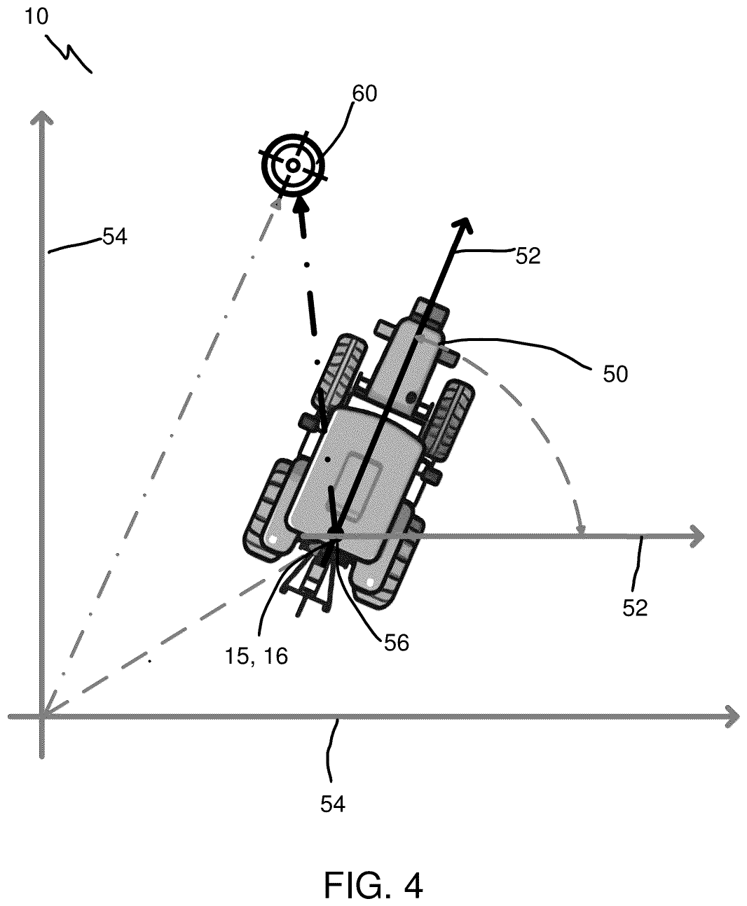

By knowing the absolute pose of the master vehicle 50 and the pose of the target vehicle 60 relative to the master vehicle 50, the absolute pose of the target vehicle 60 can be calculated using the well-known change of basis method. The change of basis method is a well known process for changing one coordinate system to another, and would be understood by those of skill in the art. A two-dimensional example of this can be seen in FIGS. 3 and 4.I

Although the absolute pose of the target/secondary vehicle 60 could be calculated by attaching a GPS and IMU to that vehicle 60 and utilizing the same sensor fusion methods as were used to compute the pose of the primary vehicle 50. But, adding on this sensor suite (GPS plus IMU) is likely to be cost prohibitive. Additionally, the addition of a sensor suite would also increase the amount of installation time and calibration needed to get a good pose estimate for the secondary vehicle 60. For example, if the primary vehicle 50 is using a GPS system 15 with RTK corrections and a high quality IMU 16, adding on the same sensors for the secondary vehicle 60 would double the cost of hardware and instillation time, in addition to the secondary vehicle 60 needing the appropriate power supply available to run such a system (e.g. a semi-trailer might not have sufficient power or power in the correct voltage).

In contrast, utilizing the disclosed non-contact relative positioning system 10 by the two vehicles may entail using a vision sensor (such as a camera (e.g. a GoPro® camera)) and a series of fiducial markers (such as AprilTags) or a series of ultra-wide band (UWB) radio transmitters on the primary vehicle 50 and receivers on the secondary vehicle 60, as will be discussed further herein. For either of these examples, the cost of the system 10 substantially less expensive than a full RTK positioning system in addition to requiring less installation and calibration time. As such, the savings are clear. These two methods are merely examples and there are many other relative positioning methods that could be used, and which would provide a similar advantage in terms of cost savings and installation time. These additional methods may include use of a variety of technologies which may utilize time-of-flight, Angle-of-Arrival, Phase-Difference-of Arrival, Two-Way-Ranging, or some other non-contact distance and/or angle measurement sensors or detectors, as would be known and appreciated by those of skill in the art.

Locating a feature found on a body fitted coordinate system 52 (e.g. one that is body fitted to the primary vehicle 50, such as a GPS and IMU sensor suite) and converting the location into a fixed coordinate system 54 (e.g. navigational or earth fitted coordinates) provides distinct benefits over currently known methods (e.g. savings in cost and set-up time or allowing for redundancy and reliability in adverse operating conditions). These benefits exist regardless of configuration or specific methodology used for triangulation, trilateration, or other method for locating and converting coordinates.

The following sections focus on non-visual methods for relative positioning for the sake of clarity and brevity, yet, the configurations, applications, benefits and methodologies discussed could rely on any non-contact methods for locating a feature in one local system, regardless of whether such a method relies on light or sound or some other non-contact method.

### Sensors/Transmitters

Using sufficient transmitters 56 on the primary vehicle 50 or platform 50 such that the relative position of the secondary vehicle 60 can be known (and thereby the absolute position of the secondary vehicle 60 can be known), allows for several beneficial use cases.

In various implementations, where the system 10 relies on certain sensor types, such as time-of-flight which only provide distance to the target, three or more transmitters 56 may be needed. Additional distance only sensor types may also include LIDAR, infrared, or ultrasonic type sensors or transmitters 56. Various further implementations, where the system 10 uses sensor types that include Angle-of-Arrival or Phase-Difference-of-Arrival methods, only one transmitter 56 may be needed, although more than one can be used. RThese sensor types may include Bluetooth (BLE), WiFi, and ulta-wideband (UWB). The systems 10 described herein would be understood to include a sufficient number of transmitters 56 on the primary vehicle 50 for relative positioning of the secondary vehicle 60, whether that number of transmitters 56 is one, two, three, or more.

### Localized Fleet Management

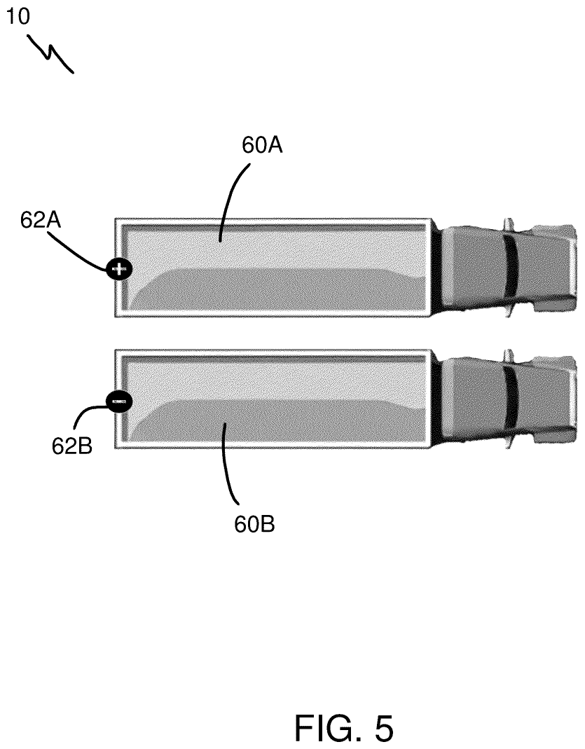

When more than one, non-primary vehicle 60A, 60B is in the area, such as in FIG. 5, it can be beneficial to know which vehicle 60A, 60B is which. For example, if one were unloading grain from a grain cart 50 into several different grain trailers 60A, 60B, it would be helpful to know which grain trailer 60A, 60B is closest to expedite unloading and it would be helpful to know which grain trailer 60A, 60B was last unloaded into to ensure that one trailer 60A is full before moving onto the a second trailer 60B. Distinguising secondary vehicles 60A, 60B may be done by placing a unique tag 62A, 62B or other unique identifier/feature 62A, 62B on each of the secondary vehicles 60A, 60B (in this example the two grain trailers 60A, 60B) and locating the secondary vehicles 60A, 60B in navigational space, as discussed herien.

In various implementations, the system 10 may be able to detect when a vehicle 50, 60 enters an area of interest. For example, one or more geolocated fixed UWB beacon may be placed an edge, entrance or other location such that when a vehicle 50, 60 nears the beacon the system 10 records that the vehicle is in the area. In a more specific example, one more beacons may be located at a field entrance such that when a vehicle 60 having a tag 62 enters the field the beacon transmits the location of the vehicle 60. The beacons may further allow for transitioning vehicle location and positioning from an on-board system to a the relative positioning system. In further implementations, after interacting with the beacon the location of the vehicle 50, 60 may be translated from a relative reference frame 52 to the navigational frame 54 using the relative position of the vehicle 50, 60 to the beacon, the beacon having a known position within the navigational frame.

Additionally, the system 10 may alert an operator that a specific vehicle type and even a specific vehicle had entered an area of interest. For example, if a specific section along the edge of a field is used as the loading area for additional seed, fertilizer, or pesticides or if a specific section of the field is used for loading grain trailers, then a notification could be presented to the operator when such a vehicle 60A, 60B entered the target zone. Because the signal is omni-directional for these types of transmitters, the primary vehicle 50 would not need to be looking in the direction of the secondary vehicle 60 to note the approach and to prepare for interaction (such as loading or unloading). When the system 10 is in use with a grain cart 50, the system 10 may allow for minimizing the amount of time spent waiting on a grain trailer 60A, 60B or having the grain trailer 600A, 60B waiting on the grain cart 50. Additionally, it would allow the grain cart 50 to focus on maintaining proper speed and distance from the harvester.

By converting the primary vehicle 50 and secondary vehicle 60 positions into navigational space their positions may be uploaded to the cloud 110 or other offsite server 106, such that a third party could geo-locate the position of all vehicles 50, 60 allowing for greater transparency, optimization of fleet use, and enabling an external operator to manage multiple vehicles 50, 60 from a remote location.

Furthermore, by converting the positions of each non-primary vehicle 60 into navigational space, their locations could be shared to and used by other vehicles are not equipped with the relative localization hardware (e.g. BLE, UWB, or ultrasonics), but are equipped with the necessary sensor suite to have a known position in navigational space.

### Collision Avoidance

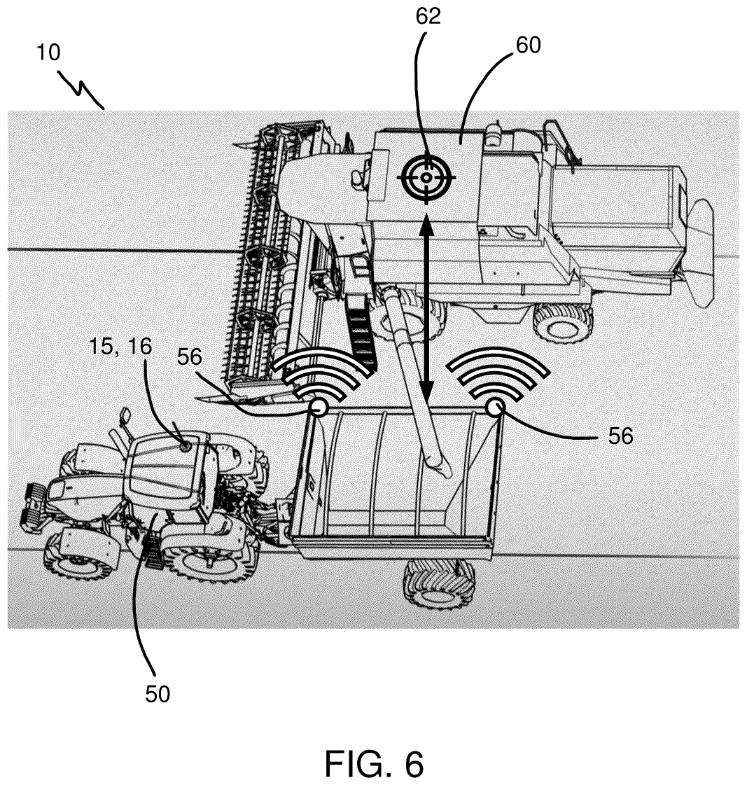

Similarly, knowing the absolute position of a vehicles in the area can be a safety feature. By knowing both the absolute position of the primary vehicle 50 and the absolute position of a secondary vehicle 60, the system 10 may set a specific no-go or lockout zone. For example, as shown in FIG. 6, if the primary vehicle 50 were a grain cart 50 and the secondary vehicle 60 were a combine 60, then the system 10 may be used to ensure a minimum spacing between the two vehicles 50, 60 is maintained. Converting the position of the combine 60 into navigation space allows for a remote operator or farm manager to see the location of the combine 60 and the location of the grain cart 50, along with the spacing between them, in real-time. This allows for less skilled operators to be hired to drive one of the two vehicles 50, 60 whilst allowing the more experienced farmers to ensure that the vehicles 50, 60 are working as expected.

In certain implementations where the primary vehicle 50 is the grain cart 50, the same transmitters that are used to geolocate the grain trailers 60 can also be used as a primary or secondary safety system when interacting with the combine harvester 60, thereby providing greater savings.

In implementations where the combine and the grain cart are both primary vehicles 50 (that is, both have absolute pose estimates due to both including GPS 15 and IMU 16 hardware onboard), the relative positioning system 10 may serve as a backup safety system.

In further implementations, if the grain cart 50 is the primary vehicle 50 for the relative positioning system 10, the system 10 may use the grain cart 50 to locate and share positional information about other vehicles 60 that wouldn't normally be equipped with a full GPS system (e.g. trucks, grain trailers, cars, etc.) and create no-go zones for the rest of the farm fleet that are equipped with GPS. This could be done without needing to place additional transmitters 56 or sensors on the other GPS equipped vehicles. For example, if a truck 60 were brought into the field to do maintenance or check on the status of crops and it were equipped with a receiver, the truck 60 could be automatically located by the primary vehicle 50 (e.g. the grain cart 50) and the truck's 60 position shared to the rest of the fleet (e.g. the combine, grain trailers, and other vehicles in the area) thereby increasing the overall safety of the fleet without requiring additional hardware.

### Using Multiple Positioning Systems

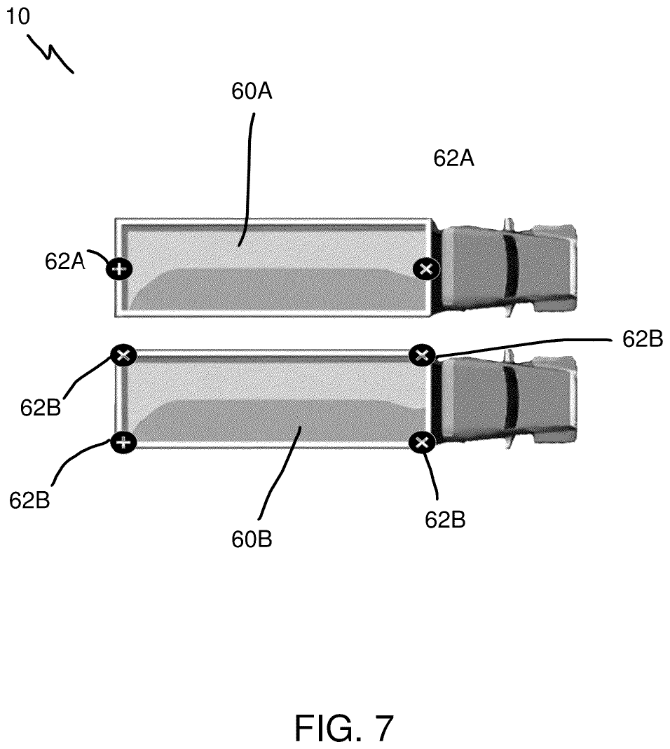

In various implementations, where the absolute pose of the primary vehicle 50 is known the absolute pose of the primary vehicle 50 can be used as a translation method between the two or more secondary vehicles 60A, 60B each being equipped with one, two, or more tags 62A, 62B or unique identifiers 62A, 62B, such as shown in FIG. 7. The system 10, in these and other implementations, may operate this way without needing to ensure that all movable platforms/vehicles 50, 60 are equipped with the same transmitter 56 types (e.g. some of the vehicles could use UWB and some could be using BLE) as long as the pose of the primary vehicle 50 is known in the global reference frame and the primary vehicle 50 has the ability to communicate using any of the tags 62A, 62B or unique identifiers 62A,62B. Optionally, the sensor/transmitter 56 is a camera and the tags 62A, 62B are visual fiducials.

By being able to communicate with a variety of tags/unique identifiers 62 the system 10 provides an additional cost savings for cases wherein the two or more tags/unique identifiers are already in use. Additionally, the cross compatibility with different styles of tags/unique identifiers 62, allows for the use of tags/unique identifiers 62 that are optimized for different use cases to interact. For example, certain field vehicles might require highly ruggedized tags/unique identifiers 62 which are capable of dealing with dust and differing lighting conditions across large distances, at the expense of some accuracy, in these cases the system 10 may rely on UWB technology. Whereas forklifts in the loading area may endure less dust and need less waterproofing but require a higher level of accuracy and may rely on structured light methods for localization. Having a centralized translation vehicle 50 or platform 50 with types of tags/identifiers 62 and a known pose for the primary vehicle 50, the various vehicles 50, 60 may then interact or avoid each other, as needs be.

As discussed above, the system 10 may utilize local datum. For example, the system 10 may include one or more beacons (optionally geolocated fixed UWB beacons) at an entrance to the field, within range of the expected parking location of a grain truck, or other location of interest. The beacone may be used to sensor and transmit the location of the vehicles (such as a grain truck 60) when it arrives or is in proximity to the beacon. In these and other implementations, the system 10 may convert the location of the vehicles 50, 60 from a relative reference frame 52 to the navigation reference frame 54 at the beacon, cloud, or other remote system from the beacon and vehicle 50, 60.

In some implementations, beacon may be place periodically (e.g. at the beginning of each day, at the beginning of the season, etc.) and their geospatial location set using a GPS receiver. Optionally, the location is set using an RTK receiver onboard a primary vehicle 50.

In certain implementations, the beacons include both short- and long-range transmitters. That is, transmitters for long range detection as well as short range sensors (e.g. UWB, BLE, camera, etc.). The use of beacons may allow for the system to determine the relative location of the vehicles 50, 60 in navigational space even when the vehicles 50, 60 are out of range from each other.

### Using Multiple Tags

Having a single receiver and knowing the position of a secondary 60 (or group of non-primary vehicles 60) relative to the primary vehicle 50 provides numerous benefits, the benefits of having multiple tags/features 62 on the secondary vehicle 60 may be higher. By having multiple tags 62 on a secondary vehicle 60, not only can its absolute position be calculated (when the absolute pose of the primary vehicle 50 is known) but the full pose of the secondary vehicle 60 can be calculated as well. For sake of clarity, the following examples will assume two-dimensional navigational space (i.e. yaw or vehicle heading is relevant but its roll and pitch are not), it would be appreciated that the system 10 may be implemented to include vehicle roll and pitch due to movement or terrain.

Adding multiple tags 62 or features 62 onto a single vehicle 60 could be done in various ways. Two examples are shown in FIG. 7. In the examples shown, one semi trailer 60A is configured such that there is a centrally located tag 62A at the front and at the back of the grain trailer 60A. In the other configuration, all four corners of the grain trailer 60B have a tag 62B. It should be clear that there are an infinite number of additional configurations that could be used to provide additional information to the system 10 and operator of the primary vehicle 50 or to the control system 10 being used to autonomously manage the two vehicles. This could include, but is certainly not limited to, having additional tags 62 on the cab of the semi 60. It should also be clear that the configuration of tags 62 may vary based on vehicle type, operation, hardware, and other factors that would be recognized by those of skill in the art. For example, the configuration when mounted to a combine would be unlikely to be the same configuration when mounted to a grain trailer.

Having multiple tags 62 which can each be seen and geo-located by the primary vehicle 50 increases the chances of the secondary vehicle 60 being located. Whereas in implementations where the vehicle 60 includes a single tag 62 the secondary vehicle 60 could be missed due to an obstructed tag 62. Having multiple tags 62 reduces the risk of that happening. For example, if all four corners of a grain trailer 60B had a tag 62B mounted on them and one tag 62B fell off, or were to be obstructed, the remaining three tags 62B could still provide a full pose for the secondary vehicle 60 thereby not losing any functionality even in this sub-optimal condition.

Having at least two geo-located features 62 on the secondary vehicle 60 allows the system 10 to draw a connecting line between the feature 62 and use standard trigonometric methods to calculate the heading of the secondary vehicle 60. This is beneficial since it allows the system 10 to know which direction the secondary vehicle 60 is facing and allowing for instructions and operation to be conducted accordingly. Similarly, the entirety of the pose of the secondary vehicle 60 could be calculated allowing for even more intelligent interactions with other vehicles.

### Guidance Line Creation

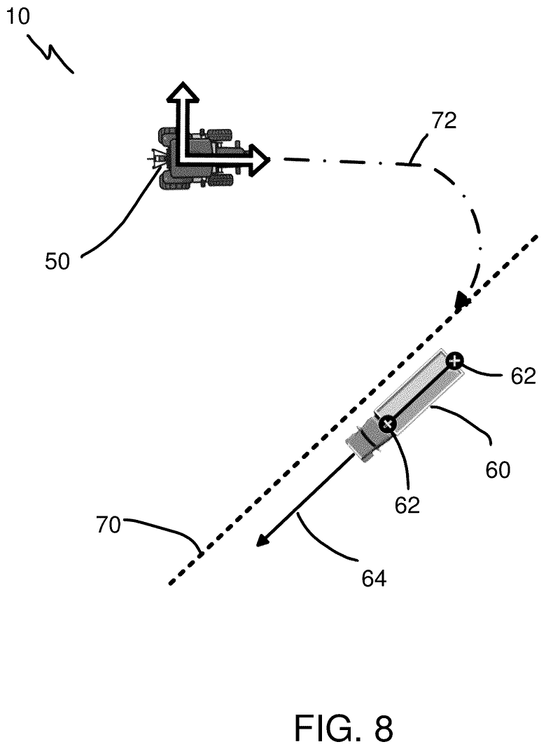

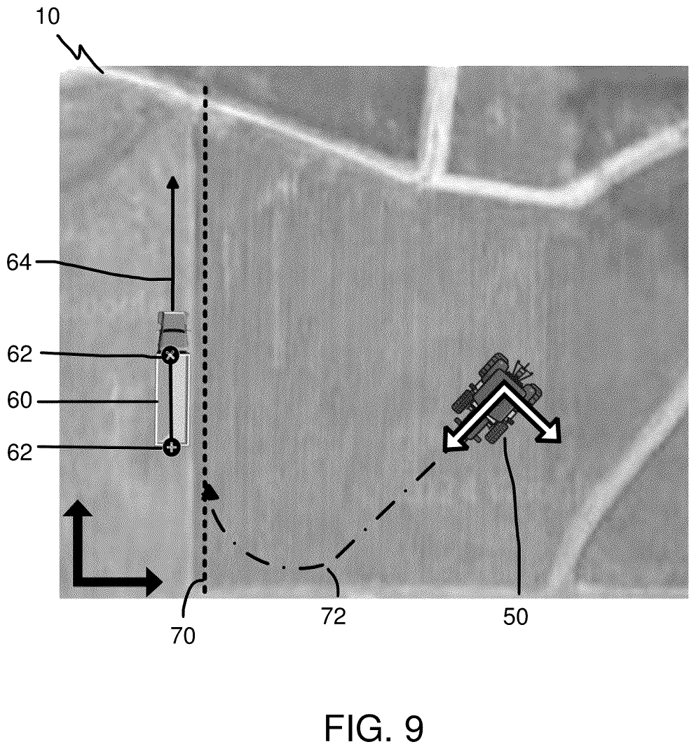

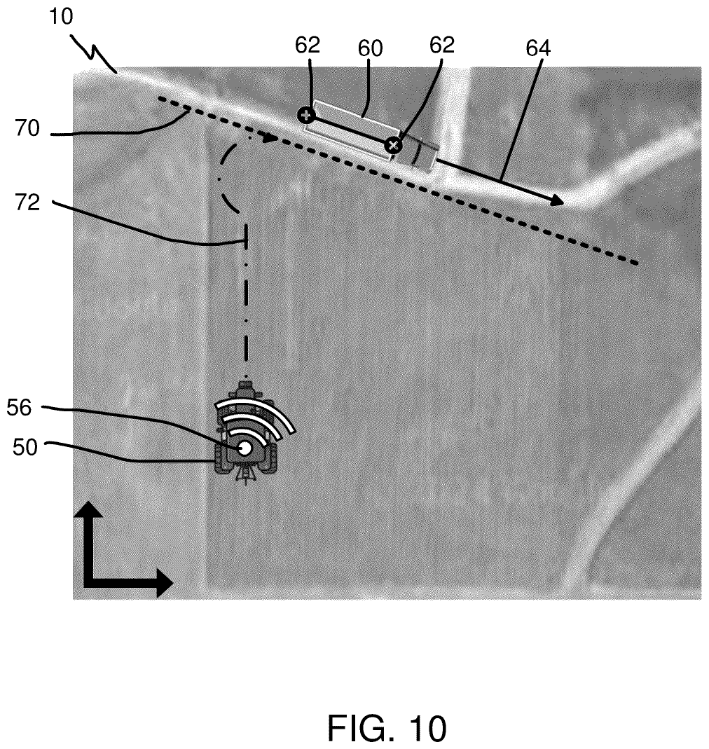

Turning to FIGS. 8-10, given the heading 64 of the secondary vehicle 60, a guidance line 70 for the primary vehicle 50 can be generated alongside the secondary vehicle 60. This can be done either by laterally offsetting the known locations of the tags 62 by the appropriate amount or by drawing a line between the two points tags 62 and then offsetting the guidance line 70. With this guidance line 70, it is then possible for the primary vehicle 50 to generate further guidance 72 to move into position to steer along this guidance line 70 with full confidence that the appropriate spacing from the secondary vehicle 60 will be maintained. Examples of this can be seen in FIGS. 8-10.

Additionally, even in the scenario where multiple grain carts 50 were being used and each of them had a known absolute pose, only one of grain cart 50 would need to be equipped with the sensor suite 56 (GPS/IMU) for determining absolute pose, because the guidance line 70 created from the offset positions of the tags 62 on the grain trailer 60 could be shared between grain carts. Thereby allowing for reliable autonomous navigation in additional scenarios without the need for additional setup or cost when adding more vehicles to the operation.

In certain implementations, the system 10 is able to transition between a GPS or other plotted guidance and guidance generated by the relative positioning system 10. That is, the primary vehicle 50 may be engaged in various operations including traversing plotted guidance, such as for harvesting crops. In this example, the vehicle 50 may determine that the secondary vehicle 60 is in proximity to the first vehicle and transition to guidance generated based of the relative position of the two vehicles 50, 60.

This advantage/use case works for in implementations having both single tag 62 and multi-tag 62 scenarios, as do the other use-cases, mentioned earlier.

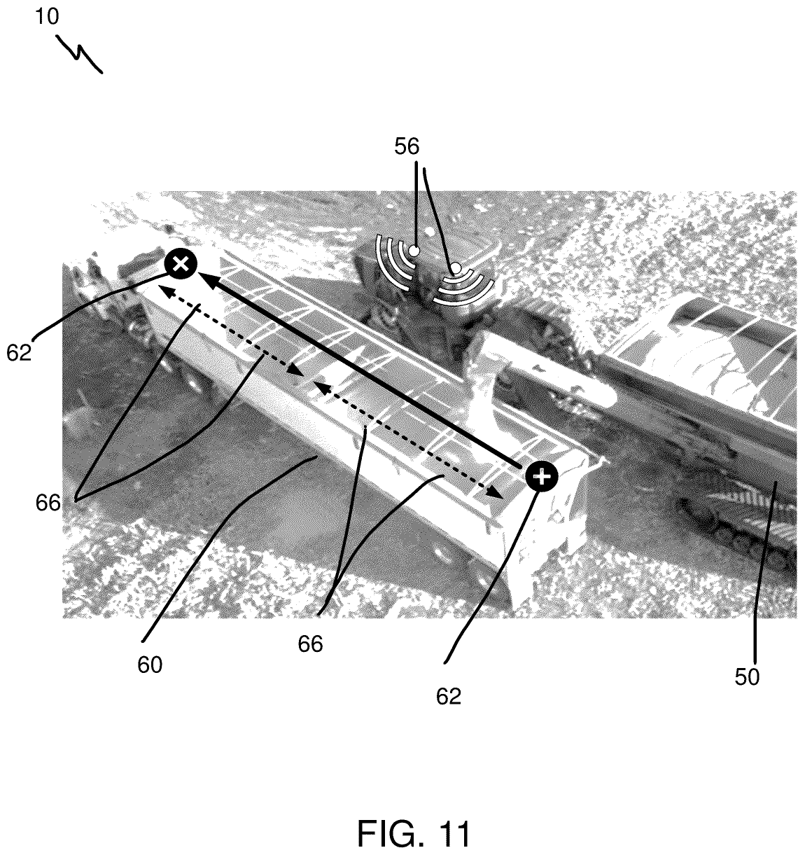

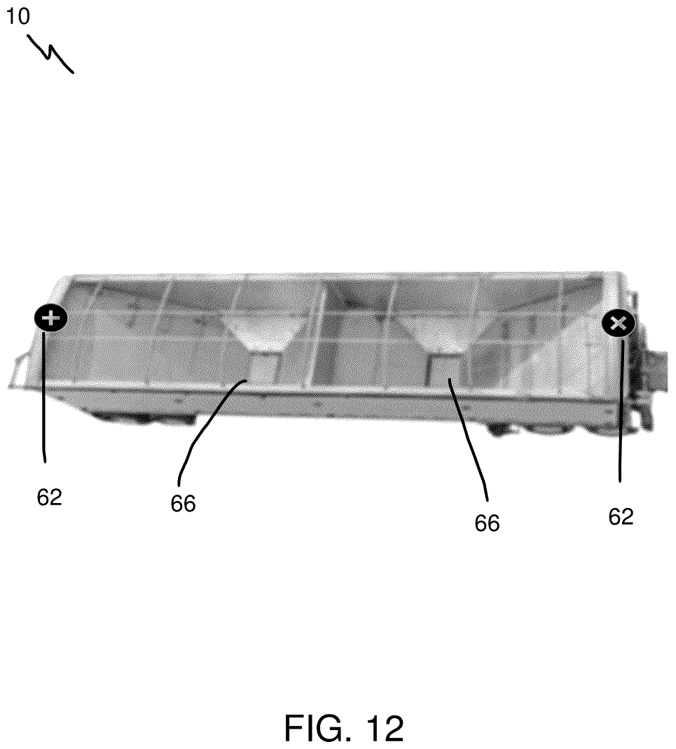

Grain trailers 60, such as the one shown in FIGS. 11-12 are generally composed of multiple chambers 66 or bays, each of which have a sloped interior. This facilitates the management of weight distribution and the unloading of the grain by overcoming its angle of repose, as would be understood.

Because grain trailers 60 have multiple chambers 66 and that grain creates mounds (the height and width of which are characterized by its angle of repose), a grain cart 50 unloading grain into a grain trailer 60 needs to move forward and backward along the length of the trailer 60 to ensure optimal weight distribution, a good loading, and to minimize spillage.

By locating the ends of the trailer 60 in navigational space and generating a guidance line 70 along side the trailer 60 with the endpoints of the trailer 60 indicated and knowing the dimensions of each of the individual hopper sections 66, an autonomously steered grain cart 50 could drive to the right trailer 60 and position the auger spout over the correct bay 66. Furthermore, by utilizing the known flow rate of the grain as it unloads from the grain cart 50 and knowing the position of the auger and spout of the grain cart 50 over the exact position of the grain trailer 60, the profile of the grain in the semi-trailer 60 can be estimated. Furthermore, using this estimate, the unloading of the grain cart 50 into the hoppers of the semi-trailer 60 could be automated, thereby reducing the complexity of the process.

Some operators may have a specific process by which they like to unload into the grain trailer 60 (e.g. loading the back first and then slowly driving forward to fill the rest of the trailer 50 or moving back and forth to maintain a uniform distribution of grain across multiple hoppers). With this in mind, supervised machine learning methods could be used to train the system 10 for unloading a grain cart 50 into a grain trailer 60 in the method preferred by the operator. Various additional machine learning and artificial intelligence system and methods could also be used to train the process of unloading grain into a grain trailer 60.

### Auto Loading a Flatbed

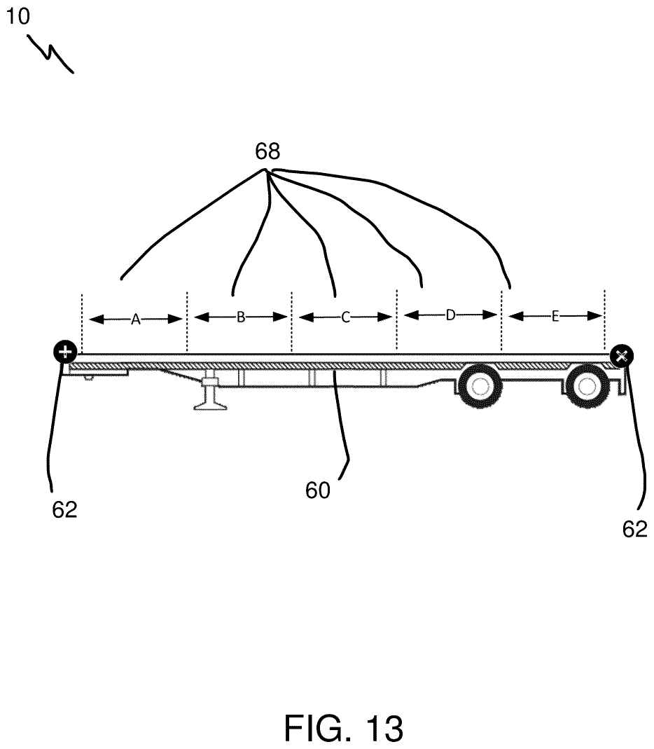

In some implementations, the primary vehicle 50 may be a forklift 50 or some other loading type vehicle 50 that operates in a yard whose absolute position is known. In these and other implementation, the secondary vehicle 60 is a flatbed 60 is equipped with tags 62 for relative localization such as those described herein, then the flatbed 60 could be virtually subdivided into specific loading bays 68. One possible way to do this can be seen in FIG. 13. There are several advantages of being able to load specific regions 68 of the trailer 60, such as weight distribution, load management, and the ability to have multiple forklifts 50 loading the same flatbed 60 at one time since they could be configured to simultaneously load different virtual bays 68.

Using the absolute position of the primary vehicle 50 to convert the virtual bays 68 of the flatbed 60 into absolute locations allows for other vehicles which may have an absolute pose but do not share the relative RTLS methods used by the flatbed 60 to still interact with the flatbed 60 and properly load, unload, or avoid it, as needed.

It should be clear that filling grain trailers 60 and loading flatbeds 60 are merely examples and the same logic could easily be applied to a variety of scenarios wherein a rigid body or rigid portions of a geolocated platform has more than one target location or region on said body. For example, when refilling a planter with seeds, there may be several dozen individual seed containers but these are all rigidly mounted onto a rigid body and are uniformly spaced (which while helpful is not necessary if the measurements of the rigid body are known). Thus, if the positions of the tags 62 on the planter frame are known in navigational space, then the positions of each of the individual seed boxes are also known. Thereby allowing autonomous refilling of the seed boxes when necessary.

### Safe Vehicle Interactions

When using a singular tag 62, the advantages in terms of no-go zones or maintaining a specific distance between adjacent vehicles was clear. When the heading of the secondary vehicle 60 is known as well as its position, the no-go zone can be reduced from a bubble to a rectangle or, even, to a perfectly fitted shape for the given platform. This allows for a greater area of operation (by not locking out unnecessary spaces) without sacrificing any of the safety advantages provided by using this system 10.

Although the disclosure has been described with references to various embodiments, persons skilled in the art will recognize that changes may be made in form and detail without departing from the spirit and scope of this disclosure.

What is claimed is:

1. A relative positioning system comprising:
(a) a first platform equipped with one or more tags; and
(b) a second platform having a known absolute pose and at least one sensor for detecting the one or more tags,
wherein the relative positioning system is configured to determine a location of the first platform via the second platform by detecting the one or more tags on the first platform and determining the pose of the first platform relative to the second platform.

2. The navigation system of claim 1, wherein the one or more tags are visual fiducials.

3. The navigation system of claim 2, wherein the at least one sensor is a camera.

4. The navigation system of claim 1, wherein the one or more tags are ultra-wide band (UWB) receivers.

5. The navigation system of claim 4, wherein the at least one sensor is a UWB transmitter.

6. The navigation system of claim 1, further comprising generating guidance for navigation of the second platform to the first platform for unloading or loading.

7. The navigation system of claim 1, wherein the absolute pose of the second platform is known from an on-board GPS and inertial measurement unit (IMU).

8. The navigation system of claim 1, wherein the first platform is a grain truck and the second platform is a grain cart.

9. An agricultural navigation system comprising:
(a) a first vehicle comprising:
(i) a sensor suite capable of determining a first vehicle absolute pose; and
(ii) at least one transmitter;
(b) a second vehicle comprising at least one tag capable of being sensed by the at least one transmitter; and
(c) a processor in communication with the sensor suite, the processor configured to determine a relative location of the second vehicle based on the first vehicle absolute pose and at least one sensed tag.

10. The agricultural navigation system of claim 9, wherein the one or more tags are visual fiducials.

11. The agricultural navigation system of claim 10, wherein the at least one transmitter is a camera.

12. The agricultural navigation system of claim 9, further comprising an automatic steering unit in communication with the processor.

13. The agricultural navigation system of claim 12, wherein the first vehicle is capable of navigating along GPS based guidance lines and switching to a relative position based guidance line.

14. The agricultural navigation system of claim 13, wherein a relative position based guidance line is generated based on the relative position of the second vehicle to the first vehicle.

15. The agricultural navigation system of claim 9, wherein the second vehicle does not include a GPS and IMU sensor suite.

16. The agricultural navigation system of claim 9, wherein the first vehicle is a grain cart and wherein the second vehicle is a grain truck.

17. A method for determining vehicle pose comprising:
determining an absolute pose of a first platform in a navigational reference frame;
sensing at least one tag on a second platform by at least one sensor on the first platform;
determining a relative location of the second platform; and
locating the second platform in the navigational reference frame.

18. The method of claim 17, wherein the absolute pose of the first platform is determined by
(a) locating the first platform in a relative reference frame via an on-board GPS and inertial measurement unit (IMU) and
(b) converting the location of the first platform into the navigational reference frame.

19. The method of claim 17, further comprising generating guidance lines for navigation of the first platform to be adjacent to the second platform.

20. The method of claim 17, wherein the at least one tag is a visual fiducial.
